(19) United States
(12) Patent Application Publication
(10) Pub. No.: US 2026/0269319 A1
(43) Pub. Date: Sep. 10, 2026

(54) ELECTROLYTE SOLUTION FOR LITHIUM/CARBON FLUORIDE BATTERIES

(71) Applicant: THE HONG KONG POLYTECHNIC UNIVERSITY, Hong Kong (CN)

(72) Inventors: Biao ZHANG, Hong Kong (CN); Zhijie WANG, Hong Kong (CN); Yanyan WANG, Hong Kong (CN)

(21) Appl. No.: 19/073,178

(22) Filed: Mar. 7, 2025

(51) Int. Cl. H01M 10/0568; H01M 4/02; H01M 4/38; H01M 4/583; H01M 10/052; H01M 10/0569

(52) U.S. Cl. CPC H01M 10/0568; H01M 4/382; H01M 4/5835; H01M 10/052; H01M 10/0569; H01M 2004/027; H01M 2004/028; H01M 2300/0037

(57) ABSTRACT

An electrolyte solution for high-temperature lithium carbon fluoride batteries, wherein the electrolyte solution includes LiPO₂F₂, a nonaqueous solvent comprising a primary solvent selected from the group consisting of a lactam, a cyclic urea, and mixtures thereof, and optionally a co-solvent; and batteries including the electrolyte solution. Batteries containing the electrolyte solution can be operated at elevated temperatures, such as 25-250° C.

### TECHNICAL FIELD

The present disclosure generally relates to electrolyte solutions useful in high-temperature batteries.

### BACKGROUND

Batteries, as efficient energy storage and conversion devices, play an essential role in modern technology. They are widely used as power sources for portable electronic devices, including cell phones, computers, and power tools. The recent rapid development of electric vehicles represents a significant breakthrough in battery applications, facilitating the reduction of carbon dioxide emissions and promoting the effective use of sustainable renewable energy sources. Despite these advances, battery systems in practical applications face significant challenges related to environmental temperature variations. In cold environments, batteries may suffer from capacity and voltage degradation or even failure, primarily due to electrolyte solidification or reduced ionic conductivity. By optimizing battery system kinetics, such as lowering electrolyte freezing points and increasing ionic conductivity, batteries can operate effectively at temperatures as low as −50° C. In contrast, the development of high-temperature batteries presents more formidable challenges. Elevated temperatures may alter the properties of electrolytes and electrodes, exacerbating side reactions between these components and increasing the risk of thermal runaway. As a result, the design of high-temperature batteries requires a comprehensive evaluation of the thermal stability and compatibility of all components.

To effectively enhance the performance of high-temperature batteries, it is crucial to thoroughly understand their specific application scenarios and requirements. One of the primary applications of high-temperature batteries is as power sources for measurement-while-drilling (MWD) and logging-while-drilling (LWD) equipment used in oil and gas exploration. In hydrocarbon-producing regions, the geothermal gradient typically ranges from 10 to 30° C. per kilometer of depth, with reservoir temperatures spanning from 60 to 120° C. In certain deep natural gas reservoirs, temperatures can even exceed 200° C. The aerospace industry represents another significant application area for high-temperature batteries, where control sensor electronics may be required to operate at temperatures reaching up to 350° C. Furthermore, high-temperature batteries are essential for powering on-board electronics in various automotive applications. For example, tire-pressure monitoring systems (TPMS) can function at temperatures as high as 125° C., while telematics boxes and eCall systems are designed to operate at temperatures up to 85° C. Additionally, high-temperature RFID electronic tags, which are extensively utilized in sterilization processes within the food industry and in medical treatments, also demand thermally stable battery systems. These diverse application requirements underscore the necessity for high-temperature batteries to possess exceptional thermal stability and reliability across a wide range of operating conditions.

Commercially available lithium-ion batteries typically exhibit significant degradation in electrochemical performance when exposed to temperatures exceeding 80° C. FIG. 8 presents an overview of existing high-temperature battery systems along with their performance specifications. For instance, lithium-iron disulfide (Li—FeS₂), lithium-chlorine (Li—Cl₂), sodium-sulfur (Na—S), and sodium-nickel chloride (Na—NiCl₂) batteries have minimum operational temperatures of 400° C., 650° C., 400° C., and 270° C., respectively, rendering them unsuitable for the aforementioned scenarios that require lower temperature thresholds. Conversely, lithium-sulfur dioxide (Li—SO₂) and lithium-manganese dioxide (Li—MnO₂) batteries have maximum operational temperatures of approximately 70° C. and 60° C., respectively, which are inadequate for high-temperature applications. Although the lithium-copper oxide (Li—CuO) battery can withstand temperatures up to 150° C., it suffers from relatively low voltage and energy density, limiting its utility in high-performance applications. Currently, lithium-thionyl chloride (Li—SOCl₂) batteries are employed in high-temperature environments due to their high energy density of up to 500 Wh/kg and wide operating temperature range. Through specialized battery structure and electrolyte design, these batteries can operate at temperatures as high as 140° C. However, this increased thermal tolerance is achieved at the cost of a significant reduction in energy density. Furthermore, thionyl chloride begins to decompose at 140° C., posing challenges to further enhancing the operational temperature of Li—SOCl₂ batteries. It is also crucial to consider that thionyl chloride is a highly toxic liquid, and elevated operating temperatures heighten the risk of leakage or explosion, necessitating stringent safety measures. Currently, Li—SOCl₂ batteries are the primary systems capable of operating within the 70-150° C. range while maintaining a relatively high energy density. However, there is a notable gap in battery technology that can meet the temperature requirements of 150-300° C. Research and development in this area are crucial to address the needs of high-temperature applications.

### SUMMARY

In a first aspect, provided herein is an electrolyte solution for a lithium carbon fluoride battery, wherein the electrolyte solution comprises LiPO₂F₂ and a nonaqueous solvent comprising a primary solvent selected from the group consisting of a lactam, a cyclic urea, and mixtures thereof.

In certain embodiments, the primary solvent is represented by the Formula 1:

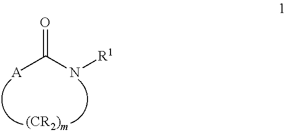

wherein m is a whole number selected from 2-6;
A is —CR₂— or —NR²—;
R for each instance is independently hydrogen or alkyl; and
each of R¹ and R² is hydrogen or alkyl.

In certain embodiments, m is 3; A is —CR₂—; and each of R, R¹, and R² is independently hydrogen or methyl.

In certain embodiments, the primary solvent is 2-pyrrolidinone, 1-methylpyrrolidin-2-one, 1,5-dimethylpyrrolidin-2-one, 5-methpyrrolidin-2-one, 2-piperidinone, 1-methylpiperidin-2-one, 3-methylpiperidin-2-one, 4-methylpiperidin-2-one, 5-methylpiperidin-2-one, 6-methylpiperdin-2-one, 1,5-dimethylpiperidin-2-one, azepan-2-one, 1-methylazepan-2-one, 7-methylazepan-2-one, 3-methylazepan-2-one, 1,3-dimethylimidazolidin-2-one, 1,3-dimethyltetrahydropyrimidin-2(1H)-one, and mixtures thereof.

In certain embodiments, the primary solvent is 2-piperidinone, azepan-2-one, azocan-2-one, azonan-2-one, or a mixture thereof.

In certain embodiments, the primary solvent is 2-piperidinone.

In certain embodiments, the nonaqueous solvent further comprises a co-solvent.

In certain embodiments, the co-solvent is selected from the group consisting of ethylene carbonate (EC), propylene carbonate (PC), dimethyl carbonate (DMC), diethyl carbonate (DEC), ethyl methyl carbonate (EMC), 1,2-dimethoxyethane (DME), tetrahydrofuran (THF), diglyme (G2), methyl acetate (MA), ethyl acetate (EA), tetraethylene glycol dimethyl ether (TEGDME), sulfolane (SL), methylsulfolane (MSL), fluoroethylene carbonate (FEC), trifluoropropylene carbonate (TFPC), a hydrofluoroether (HFE), and mixtures thereof.

In certain embodiments, the co-solvent is propylene carbonate, methyl acetate, ethyl acetate, or a mixture thereof.

In certain embodiments, the nonaqueous solvent comprises 2-piperidinone and a co-solvent selected from the group consisting of propylene carbonate (PC), methyl acetate (MA), ethyl acetate (EA), and mixtures thereof.

In certain embodiments, the 2-piperidinone is present in the nonaqueous solvent at a concentration of 30-70% v/v relative to the total volume of 2-piperidinone and the co-solvent.

In certain embodiments, the nonaqueous solvent comprises 2-piperidinone and a co-solvent selected from the group consisting of propylene carbonate (PC), methyl acetate (MA), ethyl acetate (EA), and mixtures thereof and the 2-piperidinone is present in the nonaqueous solvent at a concentration of 40-60% v/v relative to the total volume of 2-piperidinone and the co-solvent.

In certain embodiments, the 2-piperidinone is present in the nonaqueous solvent at a concentration of about 50% v/v relative to the total volume of 2-piperidinone and the co-solvent.

In certain embodiments, the electrolyte solution further comprises a secondary salt selected from the group consisting of lithium hexafluorophosphate (LiPF₆), lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiCF₃SO₃), lithium difluoro(oxalato)borate (LiDFOB), lithium bis(oxalato)borate (LiBOB), lithium nitrate (LiNO₃), and mixtures thereof.

In certain embodiments, the electrolyte solution further comprises a secondary salt selected from the group consisting of lithium bis(oxalato)borate (LiBOB), lithium nitrate (LiNO₃), and mixtures thereof.

In a second aspect, provided herein is a battery comprising a positive electrode; a negative electrode disposed opposite to the positive electrode; and the electrolyte solution described herein, wherein the positive electrode comprises a carbon fluoride material and the negative electrode comprises lithium metal or a lithium alloy.

In certain embodiments, the carbon fluoride material is selected from the group consisting of fluorinated graphite, fluorinated graphene, fluorinated carbon nanotubes, fluorinated carbon fibers, fluorinated carbon nanoparticles, fluorinated fullerene, fluorinated hard carbon, fluorinated biomass-derived carbon, and mixtures thereof.

In certain embodiments, the lithium alloy comprises Li—Al, Li—Sn, Li—Si, Li—Pb, Li—Mg, Li—B, Li—Zn, Li—In or Li—Ga alloy.

In certain embodiments, the nonaqueous solvent comprises 2-piperidinone and a co-solvent selected from the group consisting of propylene carbonate (PC), methyl acetate (MA), ethyl acetate (EA), and mixtures thereof; the 2-piperidinone is present in the nonaqueous solvent at a concentration of about 50% v/v relative to the total volume of 2-piperidinone and the co-solvent in the nonaqueous solvent; and the electrolyte solution further comprises a secondary salt selected from the group consisting of LiNO₃ and lithium bis(oxalato)borate.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts a thermogravimetric analysis (TGA) curve of CFₓ.

FIG. 2 depicts a TGA curve of LiPO₂F₂ and LiBF₄.

FIG. 3 depicts (a) the chemical structures of dimethyl acetamide (DMAC), 2-pyrrolidinone, 2-piperidinone, and azepan-2-one and (b) their stability with lithium metal.

FIG. 4 depicts discharge curves of Li—CFₓ batteries at the current density of 20 mA g⁻¹, 100 mA g⁻¹, and 1000 mA g⁻¹, using AE and CE as electrolyte, respectively, at (a) 25° C., (b) 60° C. and (c) 100° C. (d) The discharge curves of Li—CFₓ batteries at the current density of 1000 mA g⁻¹, at 150° C., 200° C., and 250° C.

FIG. 5 depicts the medium discharge voltage and specific energy density of Li—CFₓ batteries tested at 25° C., 60° C. and 100° C., using AE and CE as electrolyte, respectively.

FIG. 6. (a) The OCV versus time during the storage of Li—CFₓ batteries with CE stored at 60° C. The inserted images are the separator and lithium foil removed from the battery after 80-hour storage. (b) The OCV versus time during the storage of Li—CFₓ batteries with AE stored at 60° C., followed by the discharge curve. The inserted photo is the lithium foil removed from the battery after 1000-hour storage.

FIG. 7 depicts the discharge curves of Li—CFₓ batteries at 25° C. using different solvents. (a) PC/2-pyrrolidinone; (b) 1-methylpyrrolidin-2-one; (c) PC/3-methylpiperidin-2-one (d) PC/5-methylpiperidin-2-one; (e) PC/azepan-2-one; (f) 1,3-dimethylimidazolidin-2-one; (g) PC/1,3-dimethyltetrahydropyrimidin-2(1H)-one. The CFₓ is fluorinated hard carbon with a C/F ratio of 1.

FIG. 8 depicts the discharge curves of Li—CFₓ batteries at 25° C. using different solvents. (a) 2-piperidinone/diglyme; (b) methyl acetate/1-methylpyrrolidin-2-one; (c) ethyl acetate/1,3-dimethylimidazolidin-2-one (d) ethyl acetate/1,3-dimethyltetrahydropyrimidin-2(1H)-one. The CFₓ is fluorinated hard carbon with a C/F ratio of 1.

FIG. 9 depicts the discharge curves of Li—CFₓ batteries at 25° C. The electrolyte is 1 M LiPO₂F₂ dissolved in 2-piperidinone/PC with 1 wt % of LiBF₄ (a) and LiBOB (b), respectively. The CFₓ is fluorinated hard carbon with a C/F ratio of 1.

FIG. 10 depicts a table showing the performance specifications of existing high-temperature batteries.

FIG. 11 depicts a table showing the melting and boiling points of common organic solvents.

FIG. 12 shows an exemplary battery configuration according to certain embodiments described herein.

### DETAILED DESCRIPTION

### Definitions

The following terms shall be used to describe the present invention. In the absence of a specific definition set forth herein, the terms used to describe the present invention shall be given their common meaning as understood by those of ordinary skill in the art.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

It should be understood that the order of steps or order for performing certain actions is immaterial so long as the present teachings remain operable. Moreover, two or more steps or actions may be conducted simultaneously.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The term “alkyl” is art-recognized, and includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C₁-C₃₀ for straight chain, C₃-C₃₀ for branched chain), and alternatively, about 20 or fewer. Likewise, cycloalkyls have from about 3 to about 10 carbon atoms in their ring structure, and alternatively about 5, 6 or 7 carbons in the ring structure.

Provided herein is an electrolyte solution for a lithium carbon fluoride battery, wherein the electrolyte solution comprises LiPO₂F₂ and a nonaqueous solvent comprising a primary solvent selected from the group consisting of a lactam, a cyclic urea, and mixtures thereof.

In certain embodiments, the primary solvent is represented by Formula 1:

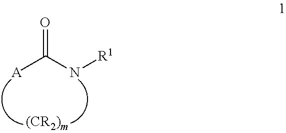

wherein m is a whole number selected from 2-6;
A is —CR₂— or —NR²—;
R for each instance is independently hydrogen or alkyl; and
each of R¹ and R² is hydrogen or alkyl.

In certain embodiments, m is 2, 3, 4, 5, or 6. In certain embodiments, m is 2-5, 2-4, 2-3, 3-4, 3-6, 4-6, or 4-5. In certain embodiments, m is 3.

R for each instance can independently be hydrogen, C₁-C₆ alkyl, C₁-C₅ alkyl, C₁-C₄ alkyl, C₁-C₃ alkyl, or C₁-C₂ alkyl.

Each of R¹ and R² for each instance can independently be hydrogen, C₁-C₆ alkyl, C₁-C₅ alkyl, C₁-C₄ alkyl, C₁-C₃ alkyl, or C₁-C₂ alkyl.

In certain embodiments, the primary solvent is a lactam represented by Formula 2:

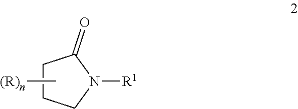

wherein n is a whole number selected from 0-4;
R for each instance is independently hydrogen, methyl, ethyl or propyl; and
R¹ is hydrogen, methyl, ethyl, or propyl.

In certain embodiments, the primary solvent is a lactam represented by Formula 3:

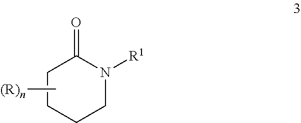

wherein n is a whole number selected from 0-4;
R for each instance is independently hydrogen, methyl, ethyl or propyl; and
R¹ is hydrogen, methyl, ethyl, or propyl.

In certain embodiments, the primary solvent is a lactam represented by Formula 4:

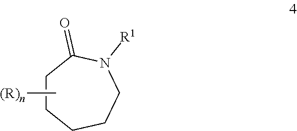

wherein n is a whole number selected from 0-4;
R for each instance is independently hydrogen, methyl, ethyl or propyl; and
R¹ is hydrogen, methyl, ethyl, or propyl.

In certain embodiments, the primary solvent is a cyclic urea represented by Formula 5:

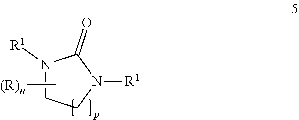

wherein n is a whole number selected from 0-4;
p is 1 or 2;
R for each instance is independently hydrogen, methyl, ethyl or propyl; and
each R¹ is independently hydrogen, methyl, ethyl, or propyl.

Exemplary primary solvents include, but are not limited to, 2-pyrrolidinone, 1-methylpyrrolidin-2-one, 1,5-dimethylpyrrolidin-2-one, 5-methpyrrolidin-2-one, 2-piperidinone, 1-methylpiperidin-2-one, 3-methylpiperidin-2-one, 4-methylpiperidin-2-one, 5-methylpiperidin-2-one, 6-methylpiperdin-2-one, 1,5-dimethylpiperidin-2-one, azepan-2-one, 1-methylazepan-2-one, 7-methylazepan-2-one, 3-methylazepan-2-one, 1,3-dimethylimidazolidin-2-one, 1,3-dimethyltetrahydropyrimidin-2(1H)-one, and mixtures thereof.

In certain embodiments, the nonaqueous solvent consists of the primary solvent. In other embodiments, the nonaqueous solvent further comprises a co-solvent. Exemplary co-solvents include, but are not limited to, EC, PC, DMC, DEC, EMC, THF, TEGDME, SL, MSL, FEC, TFPC, and HFE, and mixtures thereof.

In certain embodiments, the co-solvent comprises PC, MA, EA, or mixtures thereof.

The primary solvent can be present in the nonaqueous solvent at a concentration of 1-99% v/v relative to the total volume of the primary solvent and co-solvent. In certain embodiments, the primary solvent is present in the nonaqueous solvent at a concentration of 1-99% v/v, 10-99% v/v, 20-99% v/v, 30-99% v/v, 40-99% v/v, 50-99% v/v, 60-99% v/v, 70-99% v/v, 80-99% v/v, 90-99% v/v, 95-99% v/v, 10-90% v/v, 10-80% v/v, 10-70% v/v, 10-60% v/v, 10-50% v/v, 10-40% v/v, 10-30% v/v, 10-20% v/v, 20-80% v/v, 30-70% v/v, 40-60% v/v, 41-59% v/v, 42-58% v/v, 43-57% v/v, 44-56% v/v, 45-55% v/v, 46-54% v/v, 47-53% v/v, 48-52% v/v, or 49-51% v/v relative to the total volume of the primary solvent and the co-solvent. In certain embodiments, the primary solvent is present in the nonaqueous solvent at a concentration of about 50% v/v relative to the total volume of primary solvent and the co-solvent in the nonaqueous solvent. In certain embodiments, the nonaqueous solvent comprises 2-piperidinone and PC, wherein the 2-piperidinone is present in the nonaqueous solvent at a concentration of about 50% v/v relative to the total volume of 2-piperidinone and PC in the nonaqueous solvent.

The LiPO₂F₂ may be present in the electrolyte solution at a concentration of 0.1-5 M, or example 1-3 M.

In certain embodiments, the electrolyte solution further comprises a secondary salt. The secondary salt may be any lithium salt that is known to be useful for lithium batteries, for example, any lithium salt that is soluble in the above-mentioned nonaqueous electrolytes.

Exemplary lithium salts include, but are not limited to, LiPF₆, LiTFSI, LiFSI, LiClO₄, LiBF₄, LiCF₃SO₃, LiDFOB, LiBOB, LiNO₃, LiPO₂F₂, LiCl, LiBr, and LiI. In certain embodiments, the secondary salt is LiNO₃, LiBOB, or a combination thereof.

The secondary salt can be present in the electrolyte solution at a concentration of 0.01-3M.

The present disclosure also provides a lithium battery comprising: a positive electrode; a negative electrode disposed opposite to the positive electrode; and the electrolyte solution described herein, wherein the positive electrode comprises a carbon fluoride material and the negative electrode comprises lithium metal or a lithium alloy.

FIG. 10A depicts an exemplary battery configuration according to certain embodiments described herein, comprising a positive electrode 103; a negative electrode disposed opposite to the positive electrode 101; and the electrolyte solution described herein disposed between the positive electrode and the negative electrode 102.

The battery can be of any type known in the art. Exemplary batteries include, but are not limited to, coin cell, cylindrical cell (including 18650 cells), pouch cell, and prismatic cell.

The carbon fluoride material can be selected from the group consisting of fluorinated graphite, fluorinated graphene, fluorinated carbon nanotubes, fluorinated carbon fibers, fluorinated carbon nanoparticles, fluorinated fullerene, fluorinated hard carbon, fluorinated biomass-derived carbon, and mixtures thereof.

The lithium alloy can be selected from the group consisting of Li—Al, Li—Sn, Li—Si, Li—Pb, Li—Mg, Li—B, Li—Zn, Li—In and Li—Ga alloy.

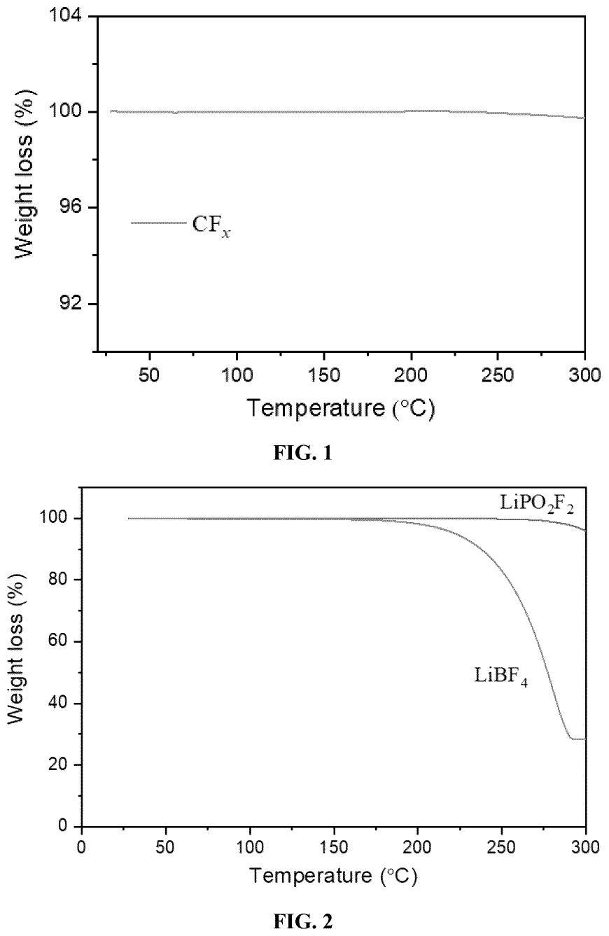

Temperature has a significant effect on the electrochemical properties of batteries, as increasing temperature typically intensifies the side reactions and accelerates battery decay. The crucial challenge in designing a high-temperature battery is to select an electrode/electrolyte combination that has superior thermostability and is compatible with each component. We chose carbon fluoride (CFₓ), a safer and more stable material, as the cathode to construct a lithium-carbon fluoride (Li—CFₓ) battery. The energy density of CFₓ is 2180 Wh/kg, significantly exceeding that of SOCl₂, which is 1470 Wh/kg, and MnO₂, which is 1005 Wh/kg. Furthermore, CFₓ exhibits remarkable thermal stability up to 300° C. as confirmed by thermogravimetric analysis (TGA) illustrated in FIG. 1. In contrast, Li—SOCl₂ batteries have a boiling point of 74.6° C. and decompose at 140° C., limiting their thermal stability. Li—CFₓ batteries present a perfect alternative to Li—SOCl₂ batteries, based on their superior energy density and thermal stability. Due to their advantages, Li—CFₓ batteries are extensively utilized as power sources in military applications, aerospace technologies, medical devices, and remote sensors. Despite these advantages, the exploration of high-temperature lithium/carbon fluoride batteries remains limited.

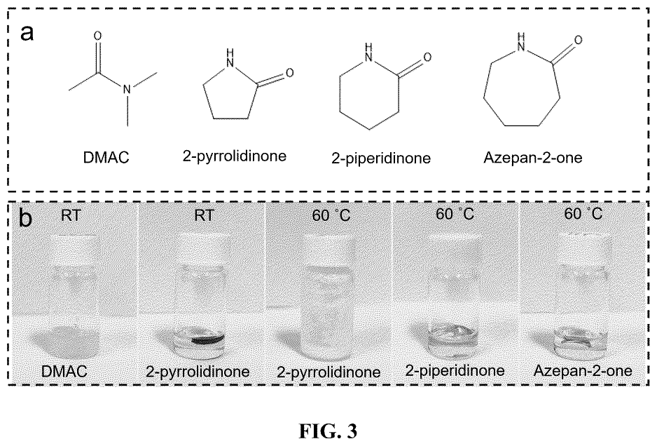

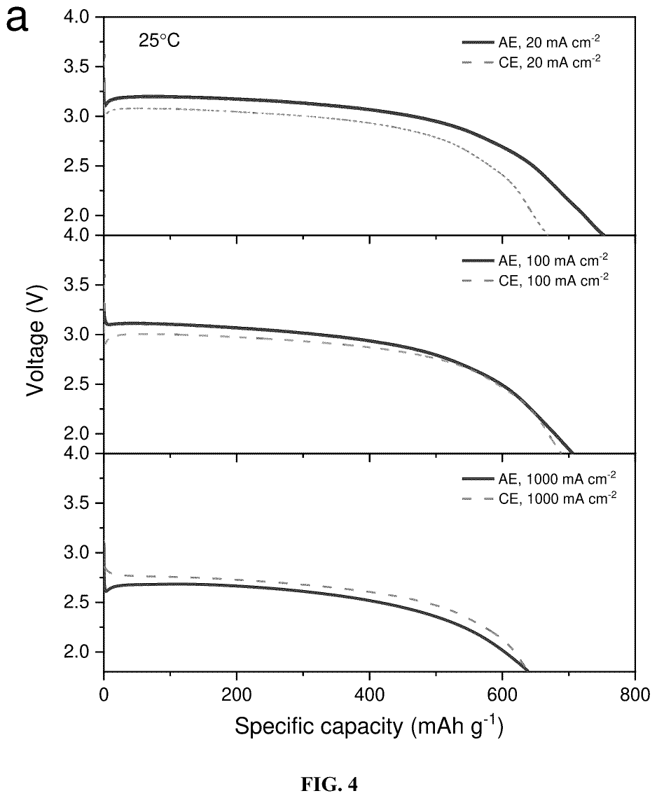

The main challenge comes from thermal stability of electrolyte. The commercially available electrolyte for Li—CFₓ battery is 1 M lithium tetrafluoroborate (LiBF₄) dissolved in propylene carbonate (PC) and dimethoxyethane (DME) mixture. Low-boiling-point organic solvents, such as DME, vaporize severely under heating, posing safety hazards and hindering lithium-ion transport. Consequently, when formulating electrolyte, we first considered solvents with low melting point, boiling point and low saturated vapor pressure, such as PC. Lithium salt selection is also essential, as the reactivity of the anions is greatly increased at high temperatures and anions may decompose at higher temperatures. As shown in FIG. 2, the decomposition of LiBF₄ begins when temperatures exceed 160° C., whereas lithium difluorophosphate (LiPO₂F₂) maintains stability even at 260° C. LiPO₂F₂ is a perfect option for high-temperature batteries due to its excellent thermostability, but its solubility in ordinary organic solvents is too low and therefore it cannot work as the primary salt in the electrolyte. To solve this dilemma, it has been advantageously been discovered that a series of strong polar solvents that contain amide functionality can surprisingly serve as a co-solvent to facilitate the dissolution of LiPO₂F₂. However, the highly polar nature of amide functional groups renders them unstable when in contact with lithium metal anodes, with side reactions becoming more pronounced at elevated temperatures. As illustrated in FIG. 3, lithium metal undergoes vigorous side reactions and dissolution in DMAC liquid. Cyclization of the amide into a lactam can effectively reduce the reactivity of the amide group. Although the five-membered lactam, 2-pyrrolidinone, exhibits less severe reactions with lithium metal compared to DMAC, its compatibility with lithium metal remains inadequate for practical applications. Increasing the ring size of the lactam further enhances the stability of the amide with lithium metal. Notably, the six-membered ring lactam, 2-piperidinone, demonstrates relatively good stability with lithium metal, maintaining compatibility even at 60° C. Similarly, the seven-membered ring lactam, azepan-2-one, also shows favorable stability under these conditions. In addition, we note that lithium nitrite (LiNO₃) and lithium bis(oxalato)borate (LiBOB) can further contribute to the stability of lithium/carbon fluoride batteries in a high temperature environment even with only 1% addition. This phenomenon is attributed to the specific adsorption behavior of NO₃⁻ and BOB⁻ anions on the lithium metal surface, resulting in the formation of a dense monolayer. This monolayer effectively inhibits direct contact between the solvent and lithium metal, thereby mitigating slow side reactions during storage. In light of these observations, a series of electrolytes comprising LiPO₂F₂ as the primary salt, propylene carbonate and amide-containing molecules as solvents, and LiNO₃ or LiBOB as additives have been developed.

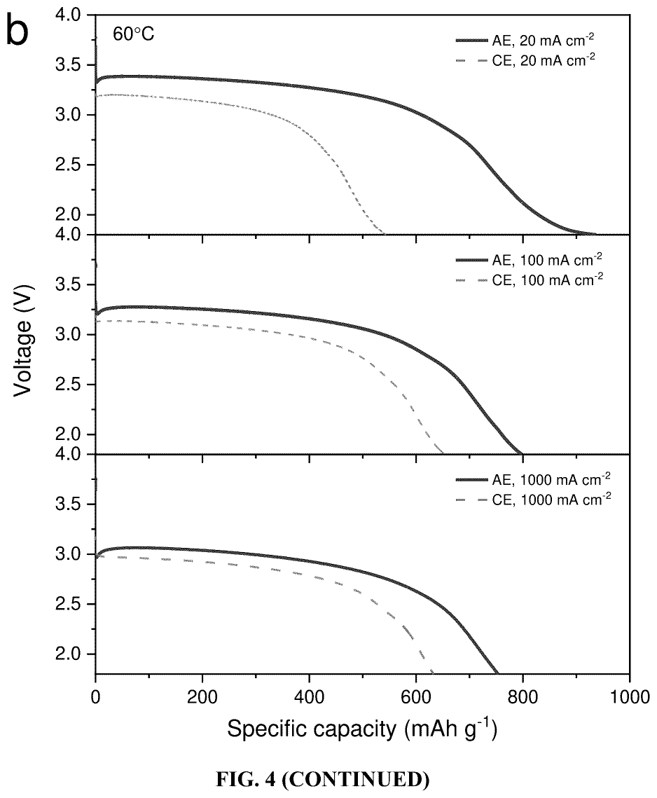

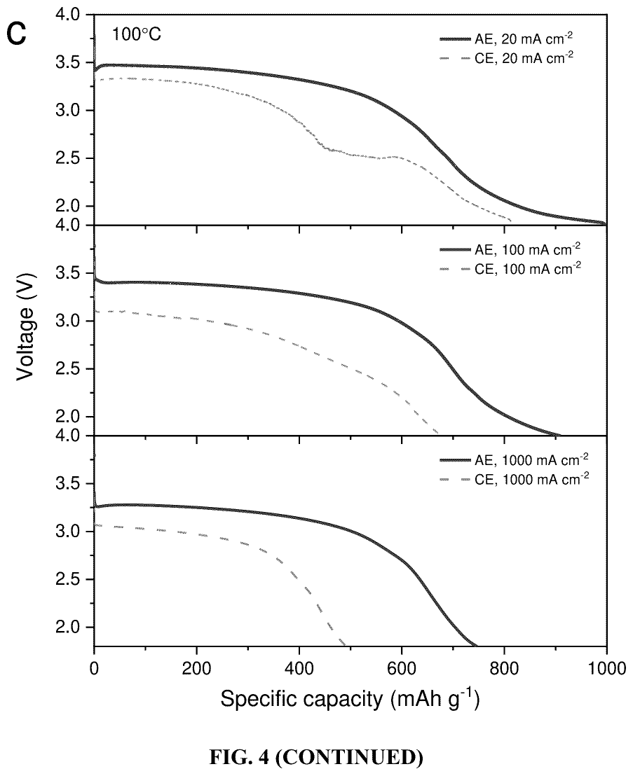

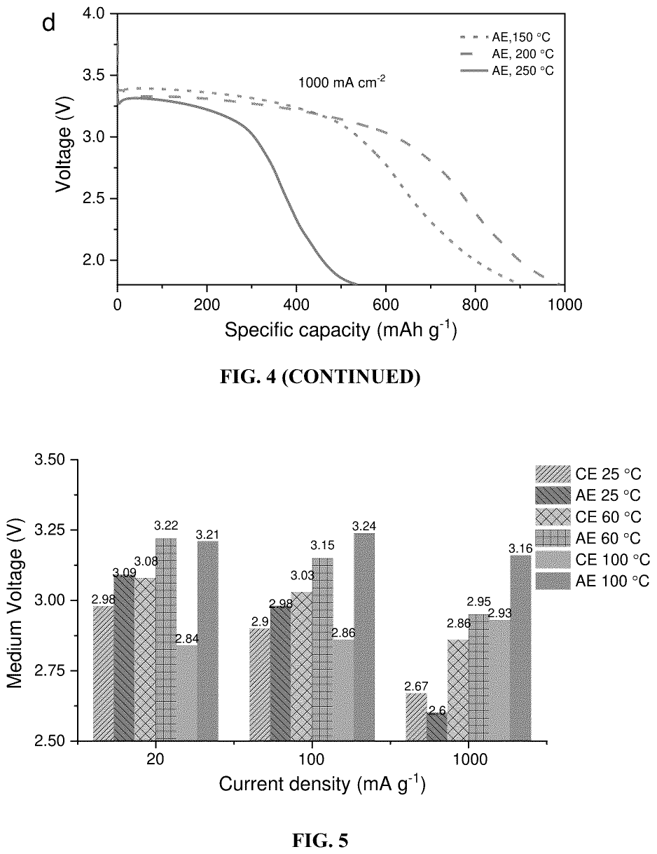

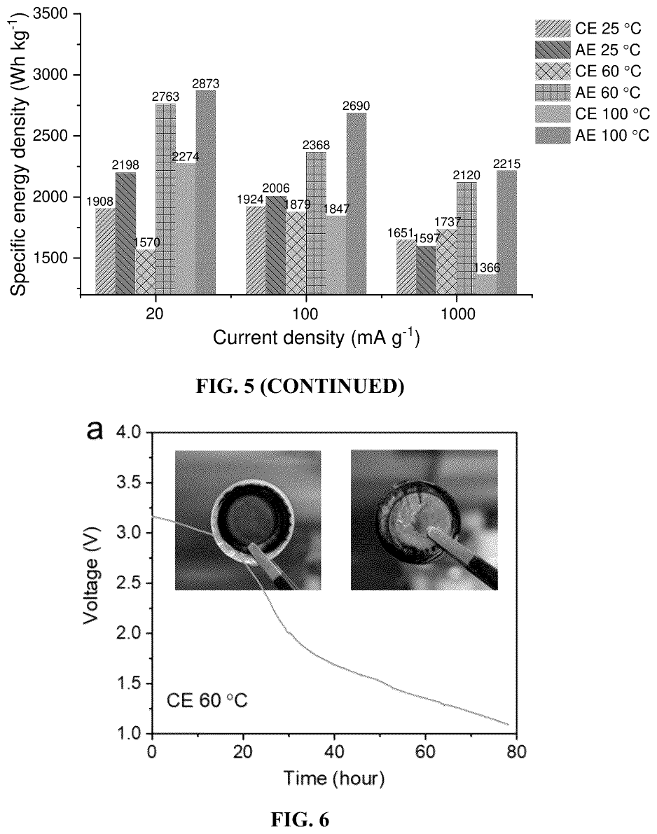

Provided herein is an electrolyte using LiPO₂F₂ as the primary salt, PC and 2-piperidinone in the volume ratio of 1:1 as the solvent, and 1 wt % LiNO₃ as the additive, noted as amide-containing electrolyte (AE). The commercial electrolyte, 1 M LiBF₄ dissolved in PC and DME in the ratio of 1:1 by volume, are denoted as CE. In FIG. 4a, the discharge voltage of Li—CFₓ batteries at 25° C. is shown to decrease with increasing current density. At a current of 20 mA g⁻¹, Li—CFₓ batteries utilizing CE electrolyte exhibit a medium discharge voltage of approximately 2.98 V, with a capacity of 670 mAh g⁻¹. In contrast, batteries using AE as the electrolyte demonstrate a slightly higher medium discharge voltage of 3.09 V and an enhanced capacity of 750 mAh g⁻¹. The increase in discharge current leads to greater polarization of the batteries. At a current of 100 mA g⁻¹, the medium discharge voltage for batteries with CE and AE electrolytes are 2.9 V and 2.98 V, respectively. Further increasing the current to 1000 mA g⁻¹ significantly impacts both the capacity and voltage output of the batteries, reducing the capacity to just 640 mAh g⁻¹. Notably, at a current of 1000 mA g⁻¹, the overall potential of Li—CFₓ batteries with CE is slightly superior to that with AE, indicating that CE retains an advantage in Li⁺ transport compared to AE. At an elevated temperature of 60° C., the advantages of AE become pronounced, as illustrated in FIG. 4b. Under a current density of 20 mA g⁻¹, the battery using AE exhibits a capacity of 920 mAh g⁻¹, with the medium discharge voltage increasing to 3.22 V. This performance is significantly superior to that of the battery with CE, which demonstrates a capacity of only 540 mAh g⁻¹ and a medium discharge voltage of 3.08 V. Consequently, the energy density of the AE-based battery is enhanced by 76% compared to its CE counterpart, reaching 2763 Wh kg⁻¹. The elevated temperature enhances the ionic conductivity of AE, enabling the battery to sustain relatively high discharge voltages and capacities at current densities of 100 mA g⁻¹ and 1000 mA g⁻¹, with energy densities exceeding those of the CE-based battery by 26% and 22%, respectively. The temperature of 60° C. mitigates the kinetic limitations of AE, resulting in minimal polarization across various current densities, and the enhancement in battery voltage due to AE is notably significant. Upon increasing the temperature to 100° C., the inadequate thermal stability of CE becomes apparent, particularly during low-current discharge, where the battery potential experiences rapid decline. Even under moderate and high current discharge conditions, the capacity performance remains suboptimal, as shown in FIG. 4c. In contrast, batteries utilizing AE demonstrate remarkable stability. At discharge current densities of 20 mA g⁻¹, 100 mA g⁻¹ and 1000 mA g⁻¹, the discharge potentials are further elevated to 3.21 V, 3.24 V, and 3.16 V, respectively, with capacities being fully realized. While CE fails to perform beyond 100° C., AE supports battery operation at elevated temperatures of 150° C., 200° C., and 250° C., as shown in FIG. 4d, exceeding the temperature range documented in current literature.

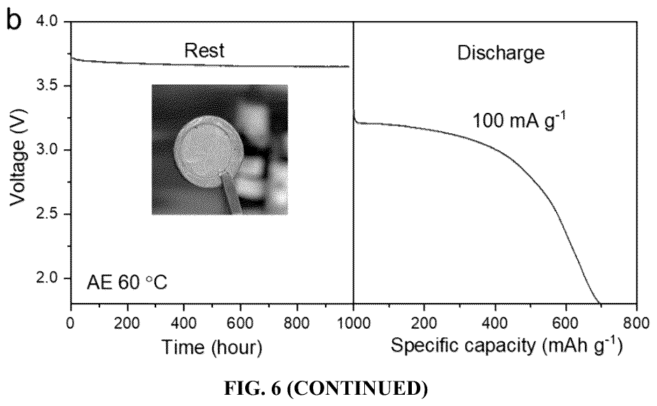

FIG. 6 presents the changes in open-circuit voltage (OCV) over time for Li—CFₓ batteries employing CE and AE, respectively, at a storage temperature of 60° C. In FIG. 6a, the battery with CE exhibits a rapid OCV decline from 3.2 V to 1 V within 80 hours. This reduction in OCV is attributed to self-discharge process occurring within the battery at elevated temperatures, resulting in the deposition of LiF on the surfaces of the separator and lithium metal. In contrast, batteries using AE as the electrolyte display remarkable stability, maintaining an almost constant OCV over a storage period of up to 1000 hours while continuing to function effectively (FIG. 6b). This indicates that batteries with AE as the electrolyte experience minimal side reactions at high temperatures. Additionally, images of the lithium foil after 1000 hours of storage reveal no evidence of reaction by-product attachment.

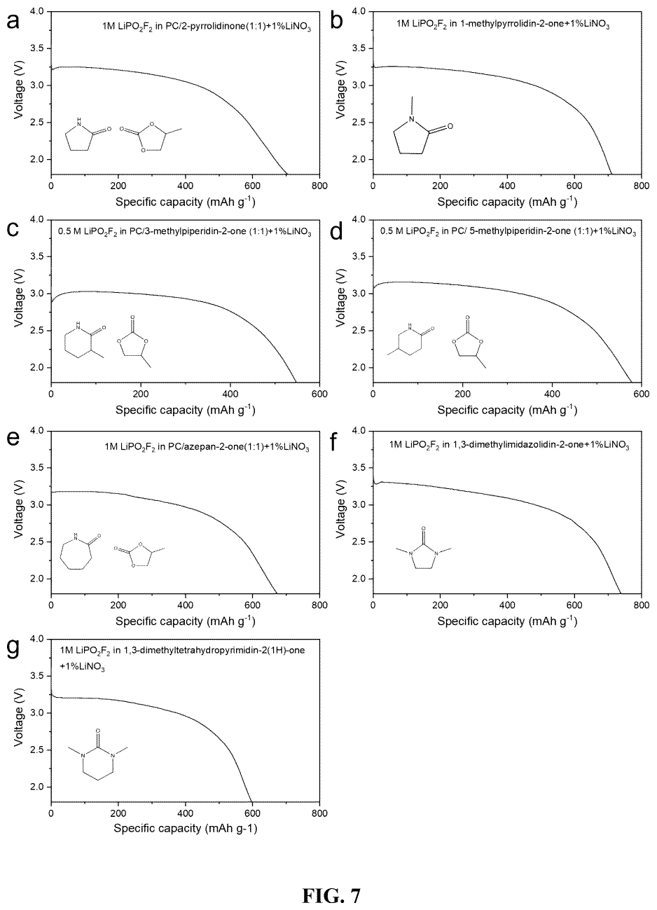

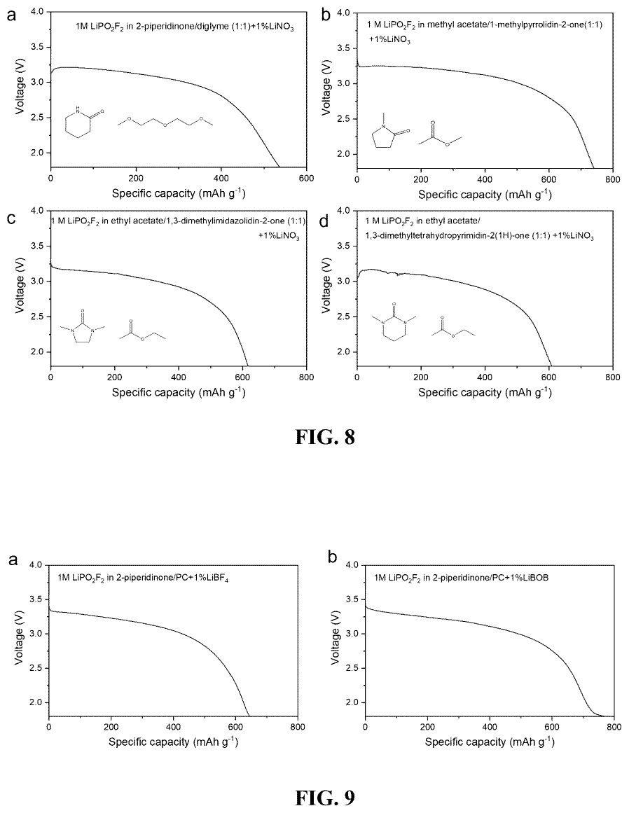

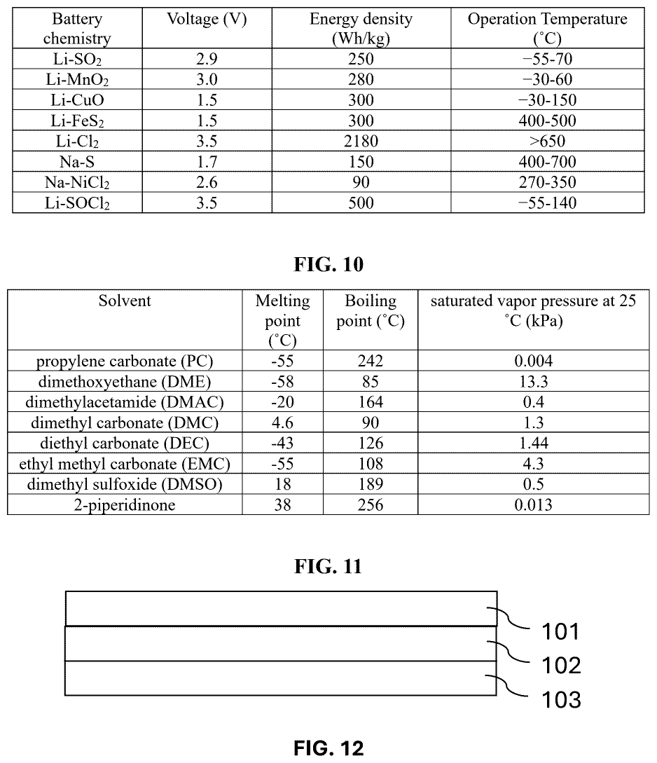

The energy density of Li—CFₓ batteries is highly related to their discharge voltage. Therefore, one viable strategy for enhancing the energy density is the substitution of the solvent. Our previous analysis demonstrated that 2-piperidinone markedly increases the discharge potential of Li—CFₓ batteries, with this enhancement being particularly pronounced at elevated temperatures. Beyond 2-piperidinone, we have identified that certain polar solvents, which contain amide functional groups exhibit similar effects. FIG. 7 presents the discharge profiles of Li—CFₓ batteries employing various solvents as electrolytes, highlighting that solvents such as 2-pyrrolidinone, 1-methylpyrrolidin-2-one, 3-methylpiperidin-2-one, 5-methylpiperidin-2-one, azepan-2-one, 1,3-dimethylimidazolidin-2-one, and 1,3-dimethyltetrahydropyrimidin-2(1H)-one are promising candidates for use as Li—CFₓ battery electrolytes.

What is claimed is:

1. An electrolyte solution for a lithium carbon fluoride battery, wherein the electrolyte solution comprises LiPO₂F₂ and a nonaqueous solvent comprising a primary solvent selected from the group consisting of a lactam, a cyclic urea, and mixtures thereof.

2. The electrolyte solution of claim 1, wherein the primary solvent is represented by the Formula 1: 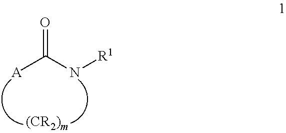
wherein m is a whole number selected from 2-6;
A is —CR₂— or —NR²—;
R for each instance is independently hydrogen or alkyl; and
each of R¹ and R² is hydrogen or alkyl.

3. The electrolyte solution of claim 2, m is 3; A is —CR₂—; and each of R, R¹, and R² is independently hydrogen or methyl.

4. The electrolyte solution of claim 1, wherein the primary solvent is 2-pyrrolidinone, 1-methylpyrrolidin-2-one, 1,5-dimethylpyrrolidin-2-one, 5-methpyrrolidin-2-one, 2-piperidinone, 1-methylpiperidin-2-one, 3-methylpiperidin-2-one, 4-methylpiperidin-2-one, 5-methylpiperidin-2-one, 6-methylpiperdin-2-one, 1,5-dimethylpiperidin-2-one, azepan-2-one, 1-methylazepan-2-one, 7-methylazepan-2-one, 3-methylazepan-2-one, 1,3-dimethylimidazolidin-2-one, 1,3-dimethyltetrahydropyrimidin-2(1H)-one, and mixtures thereof.

5. The electrolyte solution of claim 1, wherein the primary solvent is 2-piperidinone, azepan-2-one, azocan-2-one, azonan-2-one, or a mixture thereof.

6. The electrolyte solution of claim 1, wherein the primary solvent is 2-piperidinone.

7. The electrolyte solution of claim 1, wherein the nonaqueous solvent further comprises a co-solvent.

8. The electrolyte solution of claim 7, wherein the co-solvent is selected from the group consisting of ethylene carbonate (EC), propylene carbonate (PC), dimethyl carbonate (DMC), diethyl carbonate (DEC), ethyl methyl carbonate (EMC), 1,2-dimethoxyethane (DME), tetrahydrofuran (THF), diglyme (G2), methyl acetate (MA), ethyl acetate (EA), tetraethylene glycol dimethyl ether (TEGDME), sulfolane (SL), methylsulfolane (MSL), fluoroethylene carbonate (FEC), trifluoropropylene carbonate (TFPC), a hydrofluoroether (HFE), and mixtures thereof.

9. The electrolyte solution of claim 7, wherein the co-solvent is propylene carbonate, methyl acetate, ethyl acetate, or a mixture thereof.

10. The electrolyte solution of claim 1, wherein the nonaqueous solvent comprises 2-piperidinone and a co-solvent selected from the group consisting of propylene carbonate (PC), methyl acetate (MA), ethyl acetate (EA), and mixtures thereof.

11. The electrolyte solution of claim 10, wherein the 2-piperidinone is present in the nonaqueous solvent at a concentration of 30-70% v/v relative to the total volume of 2-piperidinone and the co-solvent.

12. The electrolyte solution of claim 1, wherein the nonaqueous solvent comprises 2-piperidinone and a co-solvent selected from the group consisting of propylene carbonate (PC), methyl acetate (MA), ethyl acetate (EA), and mixtures thereof and the 2-piperidinone is present in the nonaqueous solvent at a concentration of 40-60% v/v relative to the total volume of 2-piperidinone and the co-solvent.

13. The electrolyte solution of claim 12, wherein the 2-piperidinone is present in the nonaqueous solvent at a concentration of about 50% v/v relative to the total volume of 2-piperidinone and the co-solvent.

14. The electrolyte solution of claim 1, wherein the electrolyte solution further comprises a secondary salt selected from the group consisting of lithium hexafluorophosphate (LiPF₆), lithium bis(trifluoromethanesulfonyl)imide (LiTFSI), lithium bis(fluorosulfonyl)imide (LiFSI), lithium perchlorate (LiClO₄), lithium tetrafluoroborate (LiBF₄), lithium triflate (LiCF₃SO₃), lithium difluoro(oxalato)borate (LiDFOB), lithium bis(oxalato)borate (LiBOB), lithium nitrate (LiNO₃), and mixtures thereof.

15. The electrolyte solution of claim 1, wherein the electrolyte solution further comprises a secondary salt selected from the group consisting of lithium bis(oxalato)borate (LiBOB), lithium nitrate (LiNO₃), and mixtures thereof.

16. A battery comprising a positive electrode; a negative electrode disposed opposite to the positive electrode; and the electrolyte solution of claim 1, wherein the positive electrode comprises a carbon fluoride material and the negative electrode comprises lithium metal or a lithium alloy.

17. The battery of claim 16, wherein the carbon fluoride material is selected from the group consisting of fluorinated graphite, fluorinated graphene, fluorinated carbon nanotubes, fluorinated carbon fibers, fluorinated carbon nanoparticles, fluorinated fullerene, fluorinated hard carbon, fluorinated biomass-derived carbon, and mixtures thereof.

18. The battery of claim 16, wherein the lithium alloy comprises Li—Al, Li—Sn, Li—Si, Li—Pb, Li—Mg, Li—B, Li—Zn, Li—In or Li—Ga alloy.

19. The battery of claim 16, wherein the nonaqueous solvent comprises 2-piperidinone and a co-solvent selected from the group consisting of propylene carbonate (PC), methyl acetate (MA), ethyl acetate (EA), and mixtures thereof; the 2-piperidinone is present in the nonaqueous solvent at a concentration of about 50% v/v relative to the total volume of 2-piperidinone and the co-solvent in the nonaqueous solvent; and the electrolyte solution further comprises a secondary salt selected from the group consisting of LiNO₃ and lithium bis(oxalato)borate.
